(19) United States
(12) Patent Application Publication
(10) Pub. No.: US 2019/0186756 A1
(43) Pub. Date: Jun. 20, 2019

(54) Heating Appliance, in Particular Oven

(71) Applicant: Grass GmbH, Hochst (AT)

(72) Inventors: Roland Tiefnig, Gaimberg (AT); Simon Mair, Lienz (AT)

(21) Appl. No.: 16/216,300

(22) Filed: Dec. 11, 2018

(30) Foreign Application Priority Data
Dec. 14, 2017 (DE) 202017006448.0

(51) Int. Cl. F24C 15/16; A21B 3/02; A21B 3/15; F24C 15/02

(52) U.S. Cl. CPC F24C 15/168; A21B 3/02; A21B 3/07; F24C 15/02; A21B 3/15

(57) ABSTRACT

A heating appliance, in particular an oven, has a housing enclosing a heatable interior, wherein the interior is bounded at the rear by a rear wall and at the front by a door, which in a closed position closes a housing opening allowing access to the interior, wherein at least one product support for products to be heated, which can be removed from the housing after the door has been opened, is accommodated in the housing, a bulkhead movably guided by guide means between an operating position located in the region of the rear wall and a closed position, in which it is pulled out into the region of the housing opening and closes the housing opening substantially completely, is located in the interior.

### BACKGROUND OF THE INVENTION

The invention relates to a heating appliance, in particular to an oven, with a housing enclosing a heatable interior, wherein the interior is bounded at the rear by a rear wall and at the front by a door which in a closed position closes a housing opening allowing access to the interior, wherein at least one product support for products to be heated, which can be removed from the housing after the door has been opened, is accommodated in the housing.

Heating appliances of this type, e.g. baking ovens, have a housing enclosing a heatable interior, which can also be described as a muffle or baking muffle. The housing consists of a heat-resistant material, e.g. a steel material. In conventional heating appliances, the side walls of the housing are fitted with slide-in rails for product supports, in the case of a baking oven cooking product supports such as baking sheets or grids, at the side walls. At the front, the heating appliance is bounded by a door, which is designed as a downward-pivotable hatch as a rule. After the door has been opened, the interior of the housing is accessible and the product support can be pulled out together with the product. As the door is being opened, the heated air in the interior of the housing escapes to the outside.

### SUMMARY OF THE INVENTION

The invention is based on the problem or creating a heating appliance of the type referred to above which offers a higher degree of energy efficiency than conventional heating appliances.

This problem is solved by a heating appliance with the features of the independent claim 1. Further developments of the invention are specified in the dependent claims.

The heating appliance according to the invention is characterised in that a bulkhead movably guided by guide means between an operating position located in the region of the rear wall and a closed position, in which it is pulled out into the region of the housing opening and closes the housing opening substantially completely, is located in the interior.

If the door is opened and the product support is pulled out, the bulkhead once again closes the interior or the cavity of the heating appliance, and the entire interior volume of heated air is lost only once. In its closed position, the bulkhead acts as a kind of door or closure and on the one hand allows the easy removal of the product support and on the other hand allows working with the door open without any further hot air flowing outside from the interior. The interior behind the bulkhead can immediately be brought up to temperature although the door is open.

In a further development of the invention, the bulkhead is coupled to the at least one product support by coupling means in such a way that the bulkhead can be moved by pulling out the product support from the operating position into the closed position. As in the case of common heating appliances, the handle on the product support effects the displacement of the bulkhead from its operating position into its closed position. In the closed position, the bulkhead is in the region of the housing opening, closing it substantially completely, with the result that the product support is at least partially and in particular almost completely outside the housing and can therefore be removed easily, e.g. even gripped at the sides, before it is removed from the bulkhead.

In principle, however, it would also be possible not to move the bulkhead from the operating position into the closed position by pulling out the product support, but rather to displace it from the operating position into the closed position by opening the door using suitable coupling means of another kind.

In a further development of the invention, the coupling means comprise at least one hook element and at least one hook holder for releasably holding the at least one hook element. In a particularly preferred way, the at least one hook element is located on the product support and the hook holder is located on the bulkhead. In principle, however, it would also be possible to locate the hook element on the bulkhead and the hook holder on the product support. Compared to this arrangement, however, the location of the hook element on the product support is advantageous, being easier to convert and therefore more cost-effective. Furthermore, conventional product supports can be retrofitted with such hook elements, which could also be described as hang-in hooks.

In a particularly preferred variant, the hook holder has several hang-in members lying on top of one another in the vertical direction of the bulkhead for hanging in an associated hook element.

The hang-in members are expediently located in at least one holder slot formed in the bulkhead and extending in the vertical direction and occupy the slot width of the holder slot. This has the advantage that the bulkhead has no parts which project forwards, i.e. towards the interior in the operating position, but the hang-in members are recessed in the slot, so that the bulkhead as a whole forms a flat surface interrupted by at least one holder slot and in particular by two holder slots.

The hang-in members are expediently designed to be pin- or bolt-like.

In a further development of the invention, the guide means are designed such that they are secured to the rear wall on the one hand and to the bulkhead on the other hand.

In a particularly preferred way, the guide means are designed such that there is no contact with the side walls. The guide means can therefore be secured to the rear wall on the one hand and to the bulkhead and the surroundings of the side walls on the other hand.

It is possible that the guide means have a guide linkage consisting of several guide arms, which is movable in the manner of an accordion while guiding the bulkhead between the operating position and the closing position. A telescopic guide could be used as an alternative to the accordion guide linkage.

For ventilating and venting the interior of the housing, at least one ventilation hole is expediently formed in the bulkhead.

In a particularly preferred way, the heating appliance is designed as a baking oven. In this case, the housing could be described as a muffle. The product supports would be cooking product supports in this case. The product supports, in particular the cooking product supports, could be tray- or grid-like. The cooking product supports, for example, could have the form of a baking sheet and/or a backing rack and/or grid. Several such cooking product supports are expediently assigned to the baking oven, e.g. several baking sheets or grids, but it is also possible for several cooking product supports such as baking sheets or grids to be accommodated in the interior of the housing and hooked by means of their hook elements into associated hang-in members on the holder of the bulkhead.

### BRIEF DESCRIPTION OF THE DRAWINGS

A preferred embodiment is illustrated in the drawing and will be explained in greater detail below. Of the drawing:

FIG. 1 is a perspective view of a preferred embodiment of the heating appliance according to the invention, the bulkhead of the heating appliance being in the closed position.

FIG. 2 shows the heating appliance from FIG. 1 without its housing, showing the guide means for guiding the bulkhead.

FIG. 3 is a perspective view of a preferred embodiment of the heating appliance from FIG. 1, with housing but without bulkhead.

### DETAILED DESCRIPTION

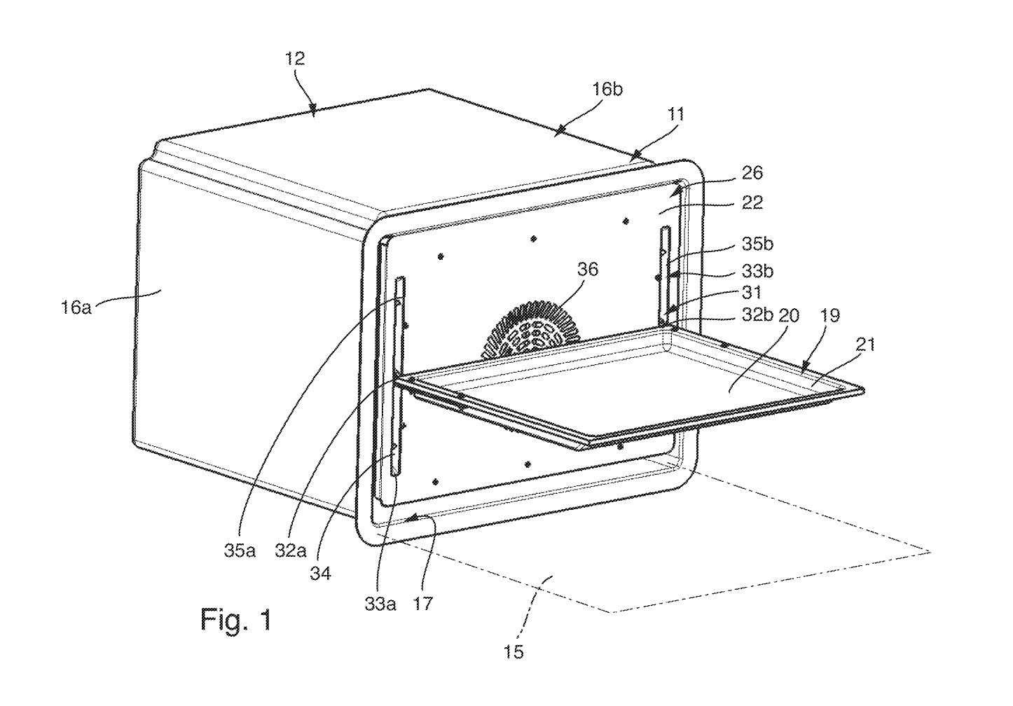

FIGS. 1 to 3 show a preferred embodiment of the heating appliance 11 according to the invention. The heating appliance 11 is explained below using an oven, in particular a baking oven, as an example In principle, however, the invention could also be used in a steamer or a microwave, although with a microwave there is no need to retain hot air, but the invention rather focuses on the easier removal of the product support.

As FIG. 1 shows in particular, the heating appliance 11 has a housing 12, which in the case of a baking oven could also be described as a muffle or baking muffle. As a rule and in the embodiment described here, the housing 12 is rectangular or cuboid in design. It is made of a heat-resistant material, in particular a steel material.

The housing 12 encloses a heatable interior 13 bounded at the rear by a rear wall 14 and at the front by a door 15. In the illustrated embodiment, the door 15 is an oven hatch which blocks access to the interior 13 in the closed position. The housing 12 further comprises to opposite side walls 16a, 16b, a floor 17 and a ceiling wall 18 located opposite thereof.

At least one product support 19 for product to be heated is accommodated in the housing 12. By way of example, the product support 19 is shown in the form of a baking sheet having a support section 20 and a raised edge section 21 extending around the support section 20.

In the interior 13 of the housing 12, there is located a bulkhead 22, which is movably guided by guide means 23 between an operating position 24 located in the region of the rear wall 14 and a closed position 26, in which it is pulled out into the region of the housing opening 25 and closes the housing opening 25 substantially completely.

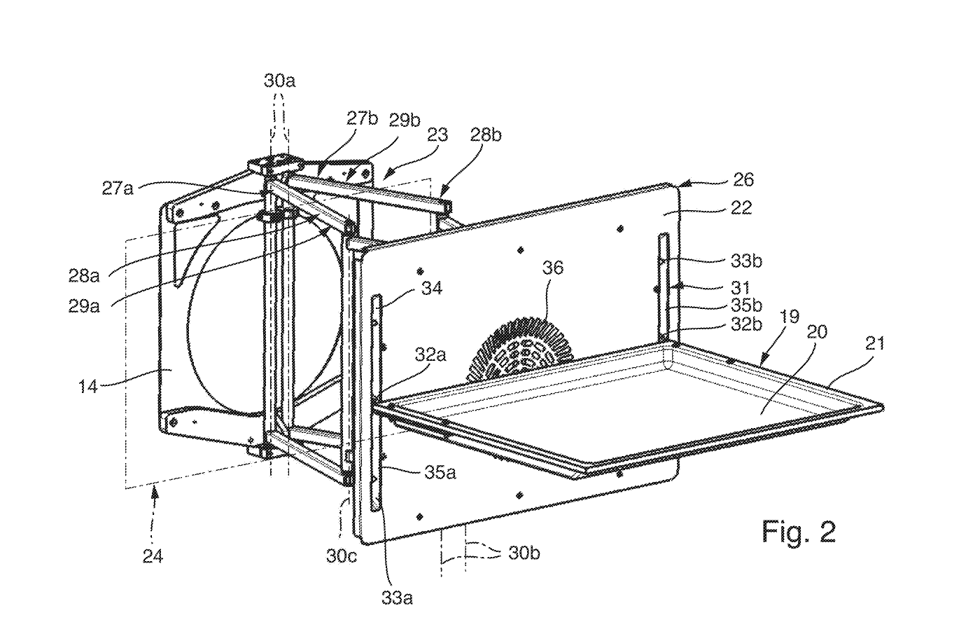

As FIGS. 1 and 2 show in particular, the bulkhead 22 is plate-shaped and likewise consists of a steel material.

The bulkhead 22 has a rectangular shape and closes the likewise rectangular housing opening 25 virtually completely in the closed position 26, as a result of which the interior 13 now lying behind the bulkhead 22 in the closed position 26 can immediately be brought up to temperature.

As mentioned above, the bulkhead 22 is movably guided by guide means 23 between the operating position 24 and the closed position.

As FIG. 2 shows in particular, the guide means 23 are designed such that they are secured to the rear wall 14 on the one hand and to the bulkhead 22 on the other hand. There is no contact with the side walls 16a, 16b.

As FIG. 2 shows in particular, the guide means 23 comprise two guide units 27a, 27b, each of which is, at a mutual transverse distance, joined to the housing 12 on the one hand and to the bulkhead 22 on the other hand.

Each of the guide units 27a, 27b has a guide linkage 29a, 29b consisting of several guide arms 28a, 28b, which is movable in the manner of an accordion while guiding the bulkhead 22 between the operating position 24 and the closed position 26.

As FIG. 2 shows in particular, the guide arms 28a, 28b are designed as pivotably connected swivel arms.

Each of the guide linkages 29a, 29b has two swivel arms, of which a first is pivotably mounted about a housing-side first pivot axis 30a and a second is pivotably mounted about a product support-side second pivot axis 30b, the two pivot axes being pivotably connected to each other via a third pivot axis 30c.

The guide means 23 are further provided with a synchronisation device (not shown) for synchronising the movement of the guide units 27a, 27b during the travel of the product support 19 coupled to the guide units 27a, 27b by way of the bulkhead 22.

As mentioned above, the bulkhead 22 is coupled to the at least one product support 19 in the form of the baking sheet by coupling means 31 in such a way that the bulkhead 22 can be moved from the operating into the closed position 26 by pulling out the product support 19.

The coupling means 31 comprise two hook elements 32a, 32b on the product support 19 and associated hook holders 33a, 33b on the bulkhead 22 for releasably holding the hook elements 32a, 32b.

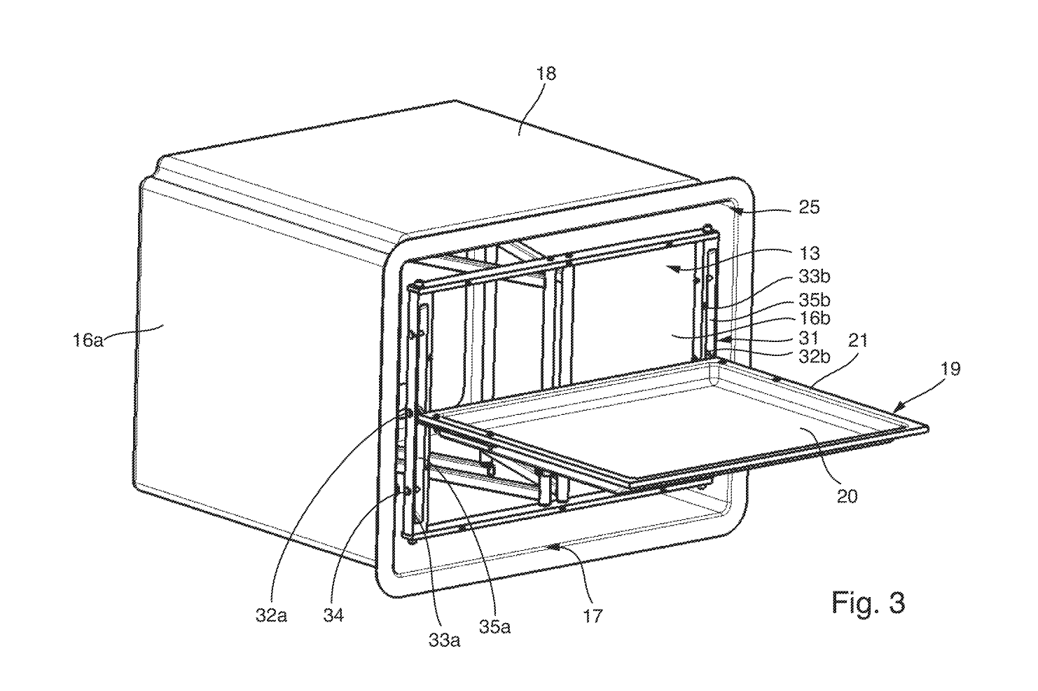

As FIG. 3 shows in particular, the hook elements 32a, 32b are secured to the edge section 21 of the baking sheet and projects towards the rear therefrom.

On the bulkhead 22 there are located two hook holders 33a, 33b, which lie in the region of the outer edge sides and each of which has hang-in members 34 located on top of one another in the vertical direction of the bulkhead 22 for hanging in the associated hook elements 32a, 32b at the baking sheet.

As FIG. 2 shows in particular, the hang-in members 34 are designed as pins or bolts and located in holder slots 34a, 34b belonging to the hook holders 33a, 33b and extending in the vertical direction of the bulkhead 22, occupying the slot width of the associated holder slot 34a, 34b.

In the illustrated embodiment, there are therefore provided in the region of the two side walls of the bulkhead 22 holder slots 35a, 35b, in which are located three hang-in members 34 arranged on top of one another, in particular with regular spacing. As a result, the baking sheet can be placed at different heights on the bulkhead, depending on the selection of hang-in members 34.

As FIG. 2 shows in particular, at least one ventilation hole 36, in particular a pattern formed from several ventilation holes, is formed on the bulkhead 22 for ventilating and venting the interior 13 of the housing 12.

During the operation of the oven, the door 15 is closed and the bulkhead 22 is in its operating position 24 in the region of the rear wall 14 of the housing 12. The interior 13 is heated to a suitable temperature, so that cooking products on the baking sheets, grids or the like are heated to a corresponding temperature. At the end of the cooking process, the door 15 or oven hatch is opened, and the baking sheet can be pulled out of the housing 12 manually, but in contrast to conventional ovens, it is not yet removed from the housing 12, but the extraction of the baking sheet causes a displacement of the bulkhead 22 from the operating position 24 into the closed position 26, in which the housing opening 25 is substantially closed completely by the bulkhead 22. The baking sheet is now substantially completely outside the housing 12, but is still located on the bulkhead 22. The bulkhead 22 screens the interior of the housing 12, so that it can quickly be brought up to temperature again. The baking sheet can be removed from the bulkhead 22 by disengaging the hook elements from the associated hang-in members 34 on the bulkhead 22, but it can also be gripped at the sides, thereby avoiding an unfavourable slant of the support section of the baking sheet, which may be covered by liquid such as gravy.

What is claimed is:

1. A heating appliance with a housing enclosing a heatable interior, wherein the interior is bounded at the rear by a rear wall and at the front by a door, which, in a closed position, closes a housing opening allowing access to the interior, wherein at least one product support for products to be heated, which can be removed from the housing after the door has been opened, is accommodated in the housing, and wherein a bulkhead is located in the interior, the bulkhead being movably guided by guide means between an operating position located in the region of the rear wall and a closed position, in which the bulkhead is pulled out into the region of the housing opening and closes the housing opening substantially completely.

2. The heating appliance according to claim 1, wherein the bulkhead is coupled to the at least one product support by coupling means in such a way that the bulkhead can be moved by pulling out the product support from the operating into the closed position.

3. The heating appliance according to claim 2, wherein the coupling means comprise at least one hook element and at least one hook holder for releasably holding the at least one hook element.

4. The heating appliance according to claim 3, wherein the at least one hook element is located on the product support and the hook holder is located on the bulkhead.

5. The heating appliance according to claim 4, wherein the hook holder has several hang-in members lying on top of one another in the vertical direction of the bulkhead for hanging in an associated hook element.

6. The heating appliance according to claim 5, wherein the hang-in members are located in at least one holder slot formed in the bulkhead and extending in the vertical direction and occupy the slot width of the holder slot.

7. The heating appliance according to claim 6, wherein the hang-in members are designed to be pin-shaped.

8. The heating appliance according to claim 1, wherein the guide means are designed such that they are secured to the rear wall on the one hand and to the bulkhead on the other hand.

9. The heating appliance according to claim 8, wherein the guide means have a guide linkage comprising several guide arms, which is movable in the manner of an accordion while guiding the bulkhead between the operating position and the closing position.

10. The heating appliance according to claim 1, wherein at least one ventilation hole is formed in the bulkhead.

11. The heating appliance according to claim 1, wherein the heating appliance is a baking oven.

12. The heating appliance according to claim 1, wherein the at least one product support is designed to be tray- or grid-like, being a baking sheet and/or a grid.
